(19) United States
(12) Patent Application Publication
(10) Pub. No.: US 2018/0313376 A1
(43) Pub. Date: Nov. 1, 2018

(54) HEAT SHRINK CLAMPING SYSTEM FOR JOINING TWO OR MORE FLUID CONDUITS IN A VEHICLE

(71) Applicant: GM Global Technology Operations LLC, Detroit, MI (US)

(72) Inventor: Matteo Presot, Torino (IT)

(21) Appl. No.: 15/865,623

(22) Filed: Jan. 9, 2018

Related U.S. Application Data
(60) Provisional application No. 62/490,337, filed on Apr. 26, 2017.

(51) Int. Cl. F16B 4/00; F16L 47/22; F16L 7/02; B29C 65/34; F16L 3/233; B29L 23/00

(52) U.S. Cl. CPC F16B 4/008; F16L 47/22; B29L 2023/22; B29C 65/3452; F16L 3/233; F16L 7/02

(57) ABSTRACT

A vehicle includes a prime mover including at least two fluid conduits, and a heat shrink sleeve provided around the at least two fluid conduits. The heat shrink tube forms a conduit bundle of the at least two fluid conduits.

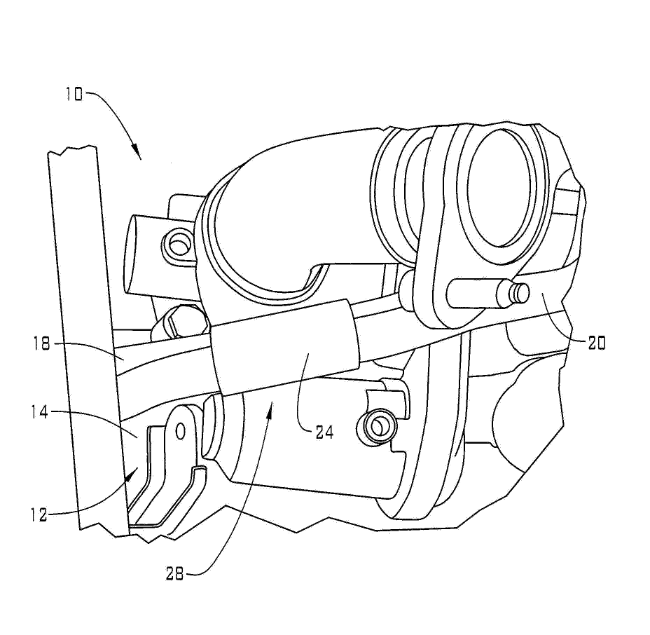

### CROSS REFERENCE TO RELATED APPLICATION

This application claims priority to U.S. application Ser. No. 62/490,337 filed Apr. 26, 2017, the disclosure of which is incorporated by reference herein in its entirety.

### INTRODUCTION

The subject disclosure relates to the art of vehicles and, more particularly, to a heat shrink clamping system for joining two or more fluid conduits in a vehicle.

Motor vehicles include a number of conduits or hoses that transport fluids to and from various vehicle systems. Conduits may be made from rubber, plastic, and metal. Material selection for a particular use may depend on fluid type. In many cases, adjacent hoses may be joined to form a hose bundle in order to conserve space, enhance appearance, and to provide protection. Hoses are joined by clips that are installed at a selected spacing to not only form the hose bundle but also provide support.

During vehicle operation, hose bundles are exposed to a number of environmental factors including changes in temperature, vibration and the like. The environmental factors may, over time, lead to clip failure causing a hose bundle to become disunited. Additionally, clips may take up desirable under hood space that could be dedicated to other systems or simply allowed to remain open for cooling and/or access purposes. Accordingly, it is desirable to provide a system for forming hose bundles that may stand up to the environmental factors as well as provide a greater amount of under hood space.

### SUMMARY

In one exemplary embodiment, a vehicle includes a prime mover including at least two fluid conduits, and a heat shrink sleeve provided around the at least two fluid conduits. The heat shrink tube forms a conduit bundle of the at least two fluid conduits.

In addition to one or more of the features described above or below, or as an alternative, further embodiments could include wherein the at least two fluid conduits are formed from a material including rubber.

In addition to one or more of the features described above or below, or as an alternative, further embodiments could include wherein the at least two fluid conduits are formed from a metal.

In another exemplary embodiment, a method of forming a fluid conduit bundle in a vehicle includes aligning two or more fluid conduits, placing a heat shrink sleeve over a portion of the two or more conduits, and applying heat to the heat shrink sleeve to join the two or more fluid conduits into a conduit bundle.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

The FIGURE depicts a vehicle including at least two fluid conduits joined by a heat shrink sleeve forming a conduit bundle, in accordance with an aspect of an exemplary embodiment.

### DETAILED DESCRIPTION

The following description is merely exemplary in nature and is not intended to limit the present disclosure, its application or uses. It should be understood that throughout the drawing, corresponding reference numerals indicate like or corresponding parts and features.

A vehicle, in accordance with an exemplary embodiment, is illustrated at 10 in the FIGURE. Vehicle 10 includes a system 12 such as a prime mover 14. Prime mover 14 may take on a variety of forms including internal combustion engines, electric motors, and hybrid motors. System 12 includes a first fluid conduit 18 and a second fluid conduit 20. The number, location, and purpose of fluid conduits may vary. First and/or second fluid conduits 18 and 20 may be formed from a material that includes rubber, metal, plastic, or combinations thereof. First and second fluid conduits 18 and 20 may be joined by a heat shrink sleeve 24 to form a conduit bundle 28.

Heat shrink sleeve 24 may take on a variety of forms, lengths, and materials. The particular length may vary depending upon conduit bundle requirements. The particular material may vary depending upon environmental factors. For example, exposure to particular chemicals, temperatures, and other environmental factors may have an impact on a particular material choice. In accordance with an exemplary aspect, heat shrink sleeve 24 may be formed out of a material that can withstand substantially continuous exposure to temperatures in excess of about 200° C. Conversely, clips, as used in the prior art, may only withstand substantially continuous exposure to temperatures of about 105° C.

In accordance with an exemplary aspect, first and second fluid conduits 18 and 20 may be aligned or placed side-by-side. Heat shrink sleeve 24 may be placed about first and second conduits 18 and 20. Heat may then be applied to heat shrink sleeve 24. The application of heat causes heat shrink sleeve 24 to contract forming conduit bundle 28. It is to be understood that the number of conduits joined to form conduit bundle 28 may vary. It also to be understood that heat shrink sleeves may include a thickness that is considerable less than that of a clip thereby leading to greater under hood space. Further, as a heat shrink sleeve may be cut to various lengths, the need to carry multiple different clips in inventory is eliminated thereby leading to a cost savings.

The terms “about” and “substantially” are intended to include the degree of error associated with measurement of the particular quantity based upon the equipment available at the time of filing the application. For example, “about” and “substantially” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A vehicle comprising:
a prime mover including at least two fluid conduits; and
a heat shrink sleeve provided around the at least two fluid conduits, the heat shrink tube forming a conduit bundle of the at least two fluid conduits.

2. The vehicle according to claim 1, wherein the at least two fluid conduits are formed from a material including rubber.

3. The vehicle according to claim 1, wherein the at least two fluid conduits are formed from a metal.

4. A method of forming a fluid conduit bundle in a vehicle comprising:
aligning two or more fluid conduits;
placing a heat shrink sleeve over a portion of the two or more conduits; and
applying heat to the heat shrink sleeve to join the two or more fluid conduits into a conduit bundle.
